(19) United States
(12) Patent Application Publication
(10) Pub. No.: US 2012/0064957 A1
(43) Pub. Date: Mar. 15, 2012

(54) GAME METHOD

(76) Inventor: Nick Han Suteerawanit, Los Angeles, CA (US)

(21) Appl. No.: 13/231,105

(22) Filed: Sep. 13, 2011

Related U.S. Application Data
(60) Provisional application No. 61/382,409, filed on Sep. 13, 2010.

(51) Int. Cl. A63F 13/00

(52) U.S. Cl. 463/9

(57) ABSTRACT

Disclosed is a method of playing a game, wherein an image is initially obscured with a plurality of cover pieces. As pieces are removed during each successive turn of the game, the image is incrementally revealed until a player successfully guesses the subject matter of the image and thereby wins a current prize value, the prize value decreasing with each piece that is removed from the board before a correct guess of the subject matter has been offered. The game may be played in a game show embodiment that includes a live studio audience, each member of the audience also being a player in the game and capable of offering guesses as to the subject matter of the image. Alternately, the game may be played as a computer-implemented method over the Internet, on a stand-alone computer, phone, or the like.

### CROSS-REFERENCE TO RELATED APPLICATIONS

This application claims the benefit of U.S. Provisional Patent Application 61/382,409, filed on Sep. 13, 2010, and incorporated herein by reference.

### STATEMENT REGARDING FEDERALLY SPONSORED RESEARCH AND DEVELOPMENT

Not Applicable.

### FIELD OF THE INVENTION

This invention relates to games, and more particularly to a method of playing a picture game.

### DISCUSSION OF RELATED ART

Game shows are popular television programs, and the excitement of the audience in such shows can be particularly contagious to those watching at home. For example, the game show “Price is Right” is notorious for having an excited, high-energy live audience, in part at least because members of the audience are selected as contestants or players. Such selection is not based on audience members' skill at any particular task, however, but rather on a closely-held selection criterion of the producers.

Several prior art patents teach so-called “cover-up games” wherein an image is obscured by a plurality of cover pieces, each of which are sequentially removed from the image so as to reveal a portion of the image. Typically one goal of the game is to correctly identify the image before all of the obscuring pieces are removed.

U.S. Pat. No. 5,221,094 to Hanson on Jun. 22, 1993, teaches such a game, as does U.S. Pat. No. 6,565,084 to Katz et al. on May 20, 2003 (FIG. 1). Such games have questions associated with each piece that must be answered correctly, diluting the image-guessing game with standard quiz-show type questions.

U.S. Pat. No. 5,056,793 to Sigle on Oct. 15, 1991 teaches a game board for a similar game that is lacking in excitement and not well-suited for use with a studio audience. No provision is made in such a device for accepting guesses from a large number of people in such an audience.

Likewise, U.S. Pat. No. 5,123,658 to Elfanbaum on Jun. 23, 1992 teaches a covered-image type game utilizing printed cards and scratch-away removable opaque areas that obscure an image printed on the card. Such a device is really best suited for a single player.

U.S. Pat. No. 6,935,945 to Orak on Aug. 30, 2005, teaches an Internet-hosted game for a plurality of players over the Internet. Participants are sent varying visual clues, but each contestant is sent differing such clues. Consequently, not everyone technically plays the same game board simultaneously, and as a result some loosing participants may feel that they were not given optimal visual clues and become discouraged.

Therefore, there is a need for a game that provides for audience members to participate based on their skill at playing the game. Such a game would provide a high-level of excitement and urgency for the audience members as well as the contestants, since the more quickly the correct image is guessed the larger the prize. The present invention accomplishes these objectives.

### SUMMARY OF THE INVENTION

The present invention is a method of playing a game, wherein an image is initially obscured with a plurality of cover pieces, each of which resembles a jigsaw puzzle piece, for example. As pieces are removed during each successive turn of the game, the image is incrementally revealed until a player successfully guesses the subject matter of the image and thereby wins a current prize value, the prize value decreasing with each piece that is removed from the board before a correct guess of the subject matter has been offered.

The game may be played in a number of different embodiments. For example, a game show embodiment may include a live studio audience, each member of the audience also being a player in the game and capable of offering guesses as to the subject matter of the image. Alternately, the game may be played as a computer-implemented method over the Internet, with a plurality of players accessing the game through the network to play and win prizes. Alternately, the game may be played as a computer-implemented software application on a stand-alone computer, phone, or the like, typically as a one or two-player game, for example. With any embodiment of the game, if the image is displayed by an electronic display device, such as a projector, or a multi-monitor display system, the pieces are virtual and are designated areas of the screen that are not displayed. In a physical implementation of the game, the pieces 30 may be opaque physical objects covering the image.

During play, the image is selected, typically at random from a pool of such images. The image is obscured with the plurality of cover pieces, and the prize value is displayed. Preferably the maximum prize value is displayed initially. The prize value may be a dollar amount, such as in the game show embodiment, or a point value, such as in the stand-alone computer-implemented embodiment.

Next, a piece is randomly selected for removal from the image. Alternately, a player may select one of the pieces for removal. Once the selected piece is removed, revealing a portion of the image that was previously obscured by the selected cover piece, any of the players may offer a guess as to the subject matter of the image. In the case of the game show embodiment, each qualifying audience member may be provided with an electronic signal device that indicates the first audience member to press a button on the signal device, for example. The first player to respond then offers his guess as to the subject matter of the image, and if that guess correctly identifies the subject of the image, then the player wins the current prize value and may optionally become eligible for additional rounds of the game. If the player guesses incorrectly as to the subject matter of the image, then that player is disqualified from further participation in that game, and possibly also from future games played that day, or for some other predetermined period of time.

If the player fails to correctly guess the subject matter of the image, then another piece is selected for removal, the prize value is reduced by a predetermined amount, and play continues as before. Play either stops when one player correctly guesses the subject matter of the image, or the price value reaches zero.

The present invention is a game method that provides for all audience members to participate based on their skill at playing the game. The present method promotes a high-level of excitement and urgency for the audience members, as well as contestants, and in at least one embodiment the home audience as well. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an elevation view of an image (such as a wall-sized image in a television game) obscured with removable cover pieces illustrating a situation wherein six cover pieces have been removed and the image is difficult to identify;

FIG. 2 is an elevation view of the image illustrating a situation wherein ten cover pieces have been removed allowing easier identification of the image;

FIG. 3 is a functional block diagram of steps in the game, wherein functional blocks are described on the figures for clarity;

FIG. 4 is a perspective view of a portable computer on which the game of the invention is played; and

FIG. 5 is a diagram of a world-wide application of the game played on a plurality of computers.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

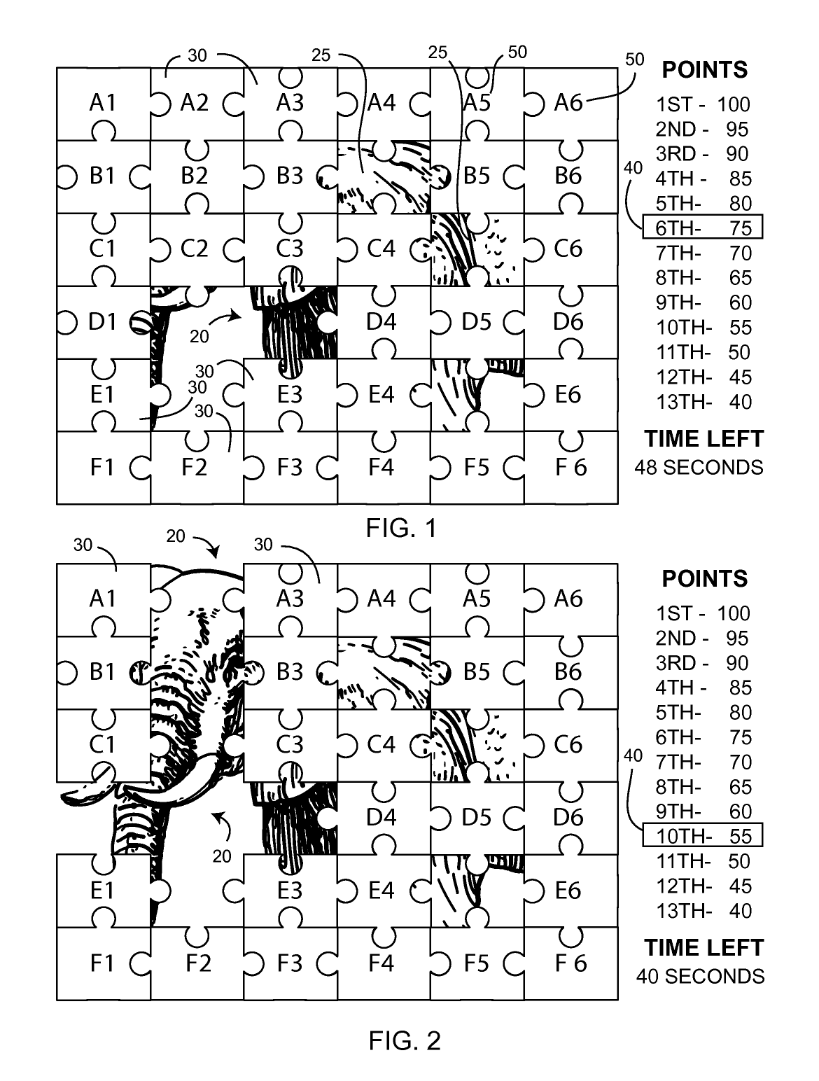

FIGS. 1-3 illustrate a method of playing a game 10, wherein an image 20 is initially obscured with a plurality of cover pieces 30, each of which resembles a jigsaw puzzle piece, for example. As pieces 30 are removed during each successive turn of the game 10, the image 20 is incrementally revealed until a player successfully guesses the subject matter of the image 20 and thereby wins a current prize value 40, the prize value 40 decreasing with each piece 30 that is removed from the board before a correct guess of the subject matter has been offered.

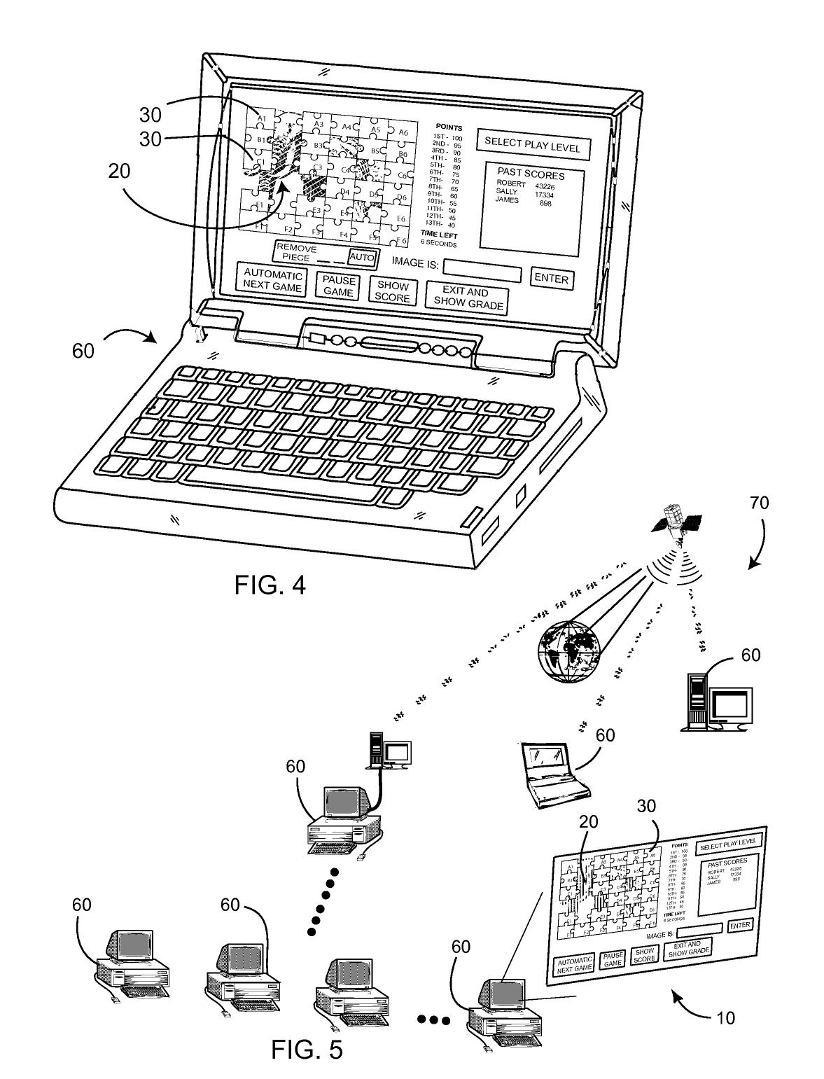

The game 10 may be played in a number of different embodiments. For example, a game show embodiment may include a live studio audience, each member of the audience also being a player in the game 10 and capable of offering guesses as to the subject matter of the image 20. Alternately, the game may be played as a computer-implemented method 60 over the Internet 70 (FIGS. 4 and 5) or other network, with a plurality of players accessing the game through the network to play and win prizes. Alternately, the game 10 may be played as a computer-implemented on a stand-alone computer, typically as a one or two-player game, for example. With any embodiment of the game 10, if the image 20 is displayed by an electronic display device, such as a projector, or a multi-monitor display system, the pieces 30 are virtual and are designated areas of the screen that are not displayed. In a physical implementation of the game 10, the pieces 30 may be opaque physical objects covering the image 20.

During play, the image 20 is selected, typically at random from a pool of such images 20. The image 20 is obscured with the plurality of cover pieces 30, and the prize value 40 is displayed. Preferably the maximum prize value 40 is displayed initially. The prize value 40 may be a dollar amount, such as in the game show embodiment, or a point value, such as in the stand-alone computer-implemented embodiment.

Next, a piece 30 is selected for removal from the image 20, such as with a random number generating routine in the case of the computer-implemented embodiments, or an air-driven random ball mixer (such as disclosed in U.S. Pat. No. 5,121,920 to Laezzo et al. on Jun. 16, 1992, for example), or the like. Alternately, a player may select one of the pieces 30 for removal. In such an embodiment, the player may identify the selected piece 30 by a unique indicia 50 applied to each piece, such as a row and column number (FIGS. 1 and 2), consecutive number (not shown), or the like. In any of the multi-player embodiments of the game 10, a random player may be selected to choose the next piece 30 for removal.

Once the selected piece 30 is removed, revealing a portion 25 of the image 20 that was previously obscured by the selected cover piece 30, any of the players may offer a guess as to the subject matter of the image 20. In the case of the game show embodiment, each qualifying audience member may be provided with an electronic signal device (not shown) that indicates the first audience member to press a button on the signal device, for example. The first player to respond then offers his guess as to the subject matter of the image 20, and if that guess correctly identifies the subject of the image 20, as judged by a panel of game show judges, or the game show host, for example, then the player wins the current prize value and may optionally become eligible for additional rounds of the game. If the player guesses incorrectly as to the subject matter of the image 20, then that player is subsequently disqualified from either the game, and possibly also from future games played that day.

In some embodiments, a predetermined number of “fastest responders” may be entertained, until either one of the most quickly responding predetermined number of players wins the prize value 40, or none of the most quickly responding predetermined number of players wins. Alternately, in any multi-player embodiment, the next player in line after the previously-guessing player may be allowed to offer a guess. Such an embodiment provides younger children, who may not be quick enough to make the first guess, the chance to play the game 10 with equal opportunity compared to the other players.

If the player or the most quickly responding predetermined number of players fail to correctly guess the subject matter of the image 20, then another piece 30 is selected for removal, the prize value 40 is reduced by a predetermined amount, and play continues as before. Play either stops when one player correctly guesses the subject matter of the image 20, or the price value 40 reaches zero. In some embodiments, guesses are accepted from players for a predetermined period of time, such as 5 to 30 seconds. If no players make a guess within that period of time, or when multiple incorrect guesses have been offered and time runs out, then another piece 30 is selected for removal, the prize value 40 is reduced by a predetermined amount, and play continues as before.

In the game show embodiment of the game 10, a home audience may also participate through Internet-connected computers, cell phone text messaging, or the like. In such an broadcast episode of the game 10 may win points towards prizes, for example, or may gain a higher position on a website “Top Players” list, for example.

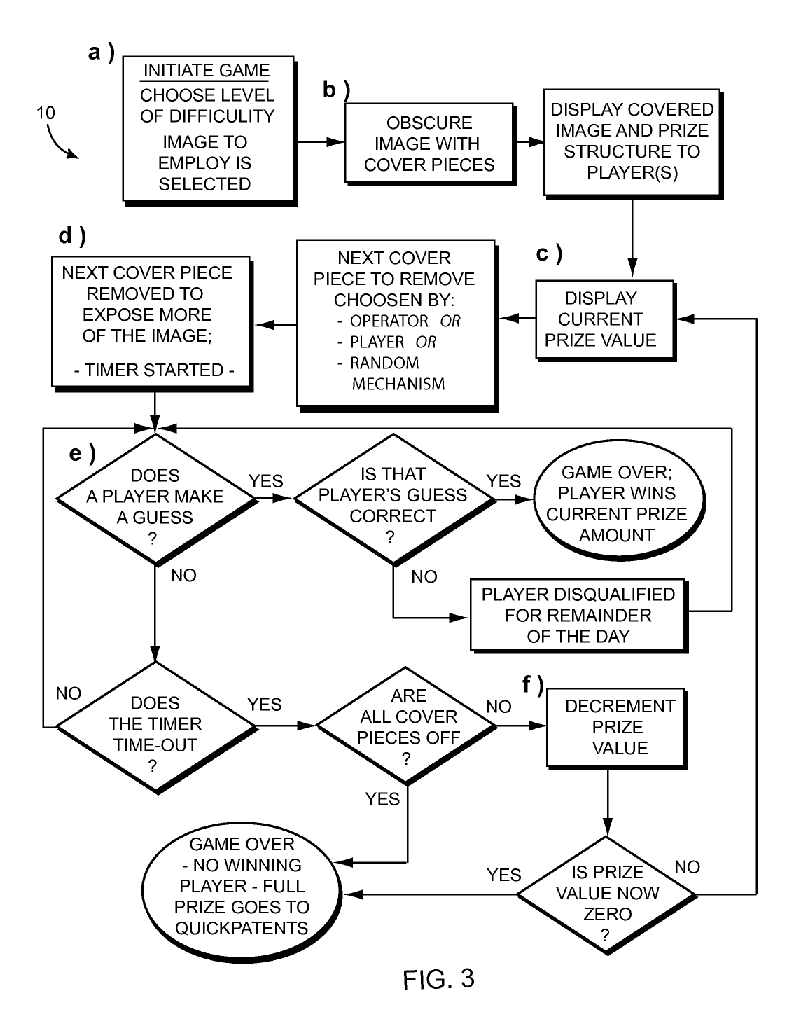

With respect to FIG. 3, which illustrates a flow chart of one embodiment of the game 10, in step a) the game 10 is initiated, and a level of difficulty is chosen. The level of difficulty may include the difficulty of the selected image 10, the number of pieces 30, or both. In step b) the image 10 is obscured with the cover pieces 30 and displayed to the at least one player. Then, in step c) the currently price value 40 is displayed. Steps b) and c) may be reversed if desired. The next cover piece 30 is selected for removal, and then in step d) the selected cover piece 30 is removed to reveal the portion 25 of the image 20 previously covered by the selected over piece 30. In step e) one or more players offer a guess of the subject matter of the image 20, and if one of the players' guess is correct then that player wins the current prize value or amount 25. Otherwise, if the players' guess is incorrect, player is disqualified and play repeats at step e) above. If a correct guess is not received within a particular predetermined time, such as 10 seconds, and provided all of the cover pieces 30 haven't already been removed from the image 20, then the prize value is decreased and, as long as the prize value is greater than zero, play repeats from step c). Otherwise, play stops with no players winning

While a particular form of the invention has been illustrated and described, it will be apparent that various modifications can be made without departing from the spirit and scope of the invention. For example, the shape of the cover pieces 30 may be altered in any number of ways. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A method of playing a game comprising the steps:
a) selecting an image to display to at least one player;
b) obscuring the image with a plurality of cover pieces, each cover piece resembling a jigsaw puzzle piece;
c) displaying a prize value associated with guessing the subject of the image;
d) selecting and removing one of the cover pieces to display a portion of the image previously obscured by the selected cover piece to the at least one player;
e) allowing any of the at least one player to guess the subject of the image within a predetermined time, and if any such guess correctly identifies the subject of the image, awarding the guessing player the prize value and stopping play;
f) reducing the prize value by a predetermined amount and repeating from step c) until either the last cover piece has been removed, or the prize value reaches zero, and then stopping play with no player winning

2. The method of claim 1 wherein the at least one player is a exactly one player.

3. The method of claim 2 wherein step d) is the player selecting one of the cover pieces to remove to display a portion of the image previously obscured by the selected cover piece.

4. The method of claim 3 wherein step b) is obscuring the image with a plurality of cover pieces, each cover piece resembling a jigsaw puzzle piece and including a unique indicia for facilitating selecting thereof.

5. The method of claim 1 wherein step a) is selecting an image to display to a plurality of players in an audience; and wherein step e) is allowing any of the players to guess the subject of the image within a predetermined time, and if any such guess correctly identifies the subject of the image, awarding the guessing player the prize value and stopping play, and if any such guess incorrectly identifies the subject of the image, disqualify the incorrectly-guessing player from future play for a present period of time.

6. The method of claim 1 wherein step d) is randomly selecting and removing one of the cover pieces to display a portion of the image previously obscured by the selected cover piece to the at least one player.

7. The method of claim 1 wherein step d) is randomly selecting one of the at least one player to select one of the cover pieces for removal, in order to display a portion of the image previously obscured by the selected cover piece to the at least one player.

8. A method of administering a game with at least one computer, comprising the steps:
a) the at least one computer randomly selecting from a pool of images an image to display to at least one player;
b) the at least one computer obscuring the displayed image with a plurality of virtual cover pieces, each cover piece resembling a jigsaw puzzle piece;
c) the at least one computer displaying a prize value associated with guessing the subject of the image;
d) selecting, and the at least one computer removing, one of the cover pieces to display a portion of the image previously obscured by the selected cover piece to the at least one player;
e) allowing any of the at least one player to guess the subject of the image within a predetermined time, and if any such guess correctly identifies the subject of the image, awarding the guessing player the prize value and stopping play;
f) reducing the prize value by a predetermined amount and repeating from step c) until either the last cover piece has been removed, or the prize value reaches zero, and then stopping play with no player winning

9. The method of claim 8 wherein the at least one player is a exactly one player.

10. The method of claim 9 wherein step d) is the player selecting, and the at least one computer removing, one of the cover pieces to display a portion of the image previously obscured by the selected cover piece to the at least one player.

11. The method of claim 10 wherein step b) is the at least one computer obscuring the displayed image with a plurality of virtual cover pieces, each cover piece resembling a jigsaw puzzle piece and including a unique indicia for facilitating selecting thereof.

12. The method of claim 8 wherein step a) is the at least one computer randomly selecting from a pool of images an image to display to a plurality of players in an audience; and wherein step e) is allowing any of the players to guess the subject of the image within a predetermined time, and if any such guess correctly identifies the subject of the image, awarding the guessing player the prize value and stopping play, and if any such guess incorrectly identifies the subject of the image, disqualify the incorrectly-guessing player from future play for a present period of time.

13. The method of claim 8 wherein step d) is randomly selecting, and the at least one computer removing, one of the cover pieces to display a portion of the image previously obscured by the selected cover piece to the at least one player.

14. The method of claim 8 wherein step d) is randomly selecting one of the at least one player to select one of the cover pieces for the at least one computer to display a portion of the image previously obscured by the selected cover piece to the at least one player.
